(19) United States
(12) Patent Application Publication
(10) Pub. No.: US 2002/0037403 A1
(43) Pub. Date: Mar. 28, 2002

(54) Metal-coating-film laminate system and a method of use of the coating in a film laminating process

(75) Inventors: Masayuki Yoshida, Yokohama-shi (JP); Ryoji Ehara, Kanagawa-ken (JP)

Correspondence Address: William G. Abbatt, Brooks & Kushman P.C., 22nd Floor, 1000 Town Center, Southfield, MI, 48075-1351, US

(73) Assignee: Henkel Corporation

(21) Appl. No.: 09/975,523

(22) Filed: Oct. 11, 2001

Related U.S. Application Data
(63) Continuation of application No. 09/230,872, filed on Feb. 1, 1999.
Application No. 09/230,872 is a 371 of international application No. PCT/US97/13685, filed on Jul. 31, 1997.

(30) Foreign Application Priority Data
Aug. 1, 1996 (JP) H8-219282

(51) Int. Cl. B32B 15/08

(52) U.S. Cl. 428/336; 428/460; 427/388.1; 427/388.4

(57) ABSTRACT

Coated metal bearing a coating on its surface that comprises phenol-, naphthol-, or bisphenol-formaldehyde resin comprising specific structural units, has a thickness from 5 to 500 nm, contains from 5 to 500 mg of carbon atoms present in the resin per m² of surface coated, and covers at least 90% of the surface of the metal can be subjected to film lamination onto the coating to provide a composite that has an excellent formability, excellent corrosion resistance, excellent adherence between the laminated film and the metal, and excellent environmental safety.

### FIELD OF THE INVENTION

This invention relates to metal that is intended to be laminated to a film, the surface of said metal having a base coating that improves the adherence between the film and the metal surface and improves the corrosion resistance of the laminated metal. The invention also relates to methods for the preparation of this coated metal. More particularly, this invention relates to metal bearing a base coating for film lamination thereon, wherein the base coating imparts an excellent corrosion resistance to the film-laminated metal and products formed therefrom and also provides a sufficiently high film adherence that the film will not debond even when the film-laminated metal is subjected to severe working operations such as drawing, draw-ironing, stretch-drawing, or the like.

### DESCRIPTION OF THE PRIOR ART

Metals such as iron, steel, aluminum, and so forth are widely used in large amounts in applications such as household electrical appliances and beverage cans, e.g., beer cans. In these applications the metal is first subjected to any of a variety of forming operations and is then painted.

Painting generally uses a solvent-borne or waterborne paint and usually is followed by a baking step. The overall painting operation is associated with a number of emissions: wastes (e.g., waste solvent, etc.) originating with the paint are discharged as industrial wastes; organic compounds (e.g., solvent and low-molecular-weight compounds) driven off during baking and offgases (mainly carbon dioxide) are discharged into the atmosphere. Among the efforts that have recently been undertaken in order to reduce industrial wastes and offgases and maintain the global environment, film-lamination technology has received attention as a replacement for painting.

A large number of inventions have already appeared on can fabrication using film lamination and in related fields. For example, Japanese Granted Patent No. 1,571,783 (“Method for the fabrication of drawn-and-ironed can”) concerns the drawironing of a polyethylene film-coated mild steel sheet. Japanese Granted Patent No. 1,711,723 (“Draw-ironed can”) describes can fabrication from stock bonded with a thermoplastic polyester coating having a prescribed orientation. Japanese Patent Application Laid Open [Kokai or Unexamined] Number Hei 2-263523 [263,523/1990] (“Method for the fabrication of thinned deep-drawn can”) concerns coating with a crystalline thermoplastic resin followed by a particular working operation. Japanese Patent Publication [Kokoku] Number Hei 7-57385 [57,385/1995] (“Method for the fabrication of coated, deep-drawn can”) teaches the use of metal sheet coated with thermoplastic resin in the form of polyester film whose main component is ethylene terephthalate. Japanese Patent Application Laid Open [Kokai or Unexamined] Number Hei 3-133523 [133,523/1991] (“Method for the fabrication of thinned drawn can”) teaches strong thinning using a laminated metal sheet composed of metal sheet and a coating layer of a particular thermoplastic resin. Japanese Granted Patent No. 1,670,957 (“Draw-ironed can”) teaches (i) providing a thermoplastic polyester coating layer and an inorganic oxide layer at the innermost surface and a plating layer of extensible metal at the outer surface wherein the plating layer is composed of specific amounts of at least one selection from a tin layer, nickel layer, and aluminum layer, and (ii) executing a thinning operation to provide a specific overall ironing ratio.

In other examples, Japanese Patent Application Laid Open [Kokai or Unexamined] Number Hei 4-91825 [91,825/1992] (“Method for the fabrication of coated, thinned can”) teaches a method that achieves an economical thinning in deep-drawn cans and generates a very strong and durable protective layer from the coating material. This is achieved by (i) using a laminated metal stock carrying an organic coating of orientable thermoplastic resin film devised to undergo an increase in crystallinity and orientation during re-drawing and (ii) carrying out working under particular drawing conditions including the use of lubricating oil. Japanese Patent Application Laid Open [Kokai or Unexamined] Number Hei 6-218465 [218,465/1994] (“Deep-drawn can and method for the fabrication thereof”) teaches coating steel sheet with a tin-containing metal at a coverage ratio of 20 to 80%; then coating with chromium metal and hydrated chromium oxide; and converting the resulting can stock into deep-drawn cans. Japanese Patent Application Laid Open [Kokai or Unexamined] Number Hei 4-224936 [224,936/1992] (“Resin-coated metal sheet for thinned deep-drawn can with an excellent resistance to denting”) teaches the formation on one or both surfaces of a metal sheet of a resin layer of polyester with a particular intrinsic viscosity. This technology provides the excellent processability and in-process corrosion resistance required of metal sheet for thinned deep-drawn cans and in particular imparts denting resistance (resistance to accidental impacts) to the formed can barrel.

Additional examples include Japanese Patent Publication [Kokoku] Number Hei 7-108706 [108,706/1995] (“Fabrication of thinned drawn can”) , which teaches the thinning draw-forming of a structure afforded by coating organic resin on surface-treated steel sheet whose substrate is cold-rolled steel sheet that satisfies several specific conditions. Japanese Patent Application Laid Open [Kokai or Unexamined] Number Hei 5-255864 [255,864/1993] (“Deep-drawn can and method for fabricating same”) teaches the fabrication of highly corrosion-resistant deep-drawn cans by coating tin-containing metal under specific conditions on steel sheet and then successively coating the entire surface thereof with chromium metal and hydrated chromium oxide and with organic resin in the order given. Japanese Patent Application Laid Open [Kokai or Unexamined] Number Hei 6-226915 [226,915/1994] (“Polycarbonate-coated metal sheet and method for preparing same”) concerns optimization for thinned deep-drawn cans by coating metal sheet with a composite resin layer whose upper ply is polycarbonate resin and whose lower ply is polyester resin. Japanese Patent Application Laid Open [Kokai or Unexamined] Number Hei 6-255022 [255,022/1994] (“Resin-coated metal sheet and method for the preparation thereof”) concerns a technology for obtaining an excellent resistance to cold impact working. This is achieved by coating the surface of metal sheet with a resin layer consisting of a blend of polycarbonate and polyester in specific proportions. Japanese Patent Application Laid Open [Kokai or Unexamined] Number Hei 6-155660 [155,660/1994] (“Polyester-coated metal sheet with excellent hot-water resistance”) relates to a technology that equips can stock with the necessary excellent processability and corrosion resistance and that prevents opacification of the can exterior even by retort treatment. This is achieved by setting up a specific crystallization ratio and specific residual biaxial orientation (prior to retort treatment) in a polyester layer adjacent to the metal sheet.

Another example is Japanese Patent Application Laid Open [Kokai or Unexamined] Number Hei 7-138786 [138,786/1995] (“Laminated steel sheet and precursor sheet therefor”) . This reference teaches that the corrosion resistance and post-processing film adherence of steel sheet coated with a thermoplastic resin film can be improved by formation in a specific configuration of chromium and tin plating layers and a hydrated chromium oxide layer on the front and rear surfaces of steel sheet. Japanese Patent Application Laid Open [Kokai or Unexamined] Number Hei 6-238818 [238,818/1994] (“Coated metal sheet can stock and seamless can formed therefrom”) teaches a technology for effectively suppressing foaming over, when a carbonated beverage is opened. In this technology, a biaxial molecular orientation is imparted to the surface of polyester film on the inner can surface with the average height, at three points, for the large projections measured when a coarse region is selected in the visual field in an atomic force microscope being specified. In Japanese Patent Application Laid Open [Kokai or Unexamined] Number Hei 7-178485 [178,485/1995] (“Two-piece can with excellent impact resistance”), improved impact resistance and improved corrosion resistance are obtained by specifying the intrinsic viscosity, degree of axial orientation, and degree of planar orientation of an oriented crystal-containing polyester resin that is the main component of the organic resin.

The substrates for bonding in these references are an inorganic oxide layer formed by chromate treatment, chromate/phosphate treatment, or electrolytic chromate treatment (Japanese Granted Patent No. 1,670,957); chromium metal and hydrated chromium oxide (Japanese Patent Application Laid Open Number Hei 6-218,465); electrolytic chromate-treated steel sheet, precoated tin-free steel (hereinafter usually abbreviated as ″TFS), hydrated chromium oxide coating, composite plating, or alloy plating (Japanese Patent Application Laid Open Number Hei 4-224,936); a hydrated chromium oxide coating at 3 to 30 milligrams of coating per square meter of surface coated (hereinafter usually abbreviated as “mg/m²”) as chromium (Japanese Patent Application Laid Open Number Hei 6-226,915); and tin-plated steel sheet or precoated TFS (Japanese Patent Application Laid Open Number Hei 7-138,786). Thus, the bonding substrates in these references can be classified into tin plate coatings and chromium-based coatings. However, tin is expensive, and toxic hexavalent chromium is used in the treatments that give the chromium-based coatings.

Paintless can fabrication systems have in fact been realized in practice through the application of the inventions in the references given above. These systems involve the lamination of precoated TFS with polyester film followed by stretch-drawing to fabricate the can. This technology omits the heretofore used painting processes (painting and baking) by substituting the laminated film for the paint film.

This technology has received a great deal of attention as a new approach to beverage can fabrication. At the present time, however, this technology exclusively employs TFS on which a chromium-based coating treatment has been executed, because neither a laminating film nor a laminating method has been developed that can meet the twin demands of high film adherence to the can stock (necessary due to the severe working that occurs after film lamination) and post-processing corrosion resistance (necessary to prevent corrosion by the various contents later put into the cans). As noted above, toxic hexavalent chromium is used in this coating treatment, with the result that the appearance of a chromium-free treatment and coating is strongly desired.

### Problems to Be Solved by the Invention

The present invention seeks to solve the problems described above for the prior art. In more specific terms, an object of the present invention is to provide metal stock bearing a chromium-free base coating for film lamination thereon wherein the film-laminated metal exhibits an excellent adherence by the laminated film and excellent corrosion resistance even after it has been subjected to severe working operations such as, for example, drawing, draw-ironing, and stretch-drawing. An additional object of the present invention is to provide methods for fabricating this coated metal stock.

### SUMMARY OF THE INVENTION

It has been discovered that the objects listed above could be realized by a coated metal whose surface is coated with a special polymer at a particular coating thickness, a particular coating weight, and a particular coverage ratio.

In specific terms, the present invention relates to coated metal bearing a coating on its surface for film lamination thereto, wherein: the thickness of the coating is from 5 to 500 nanometers (hereinafter usually abbreviated as “nm”) ; the total mass per unit area of carbon atoms in the coating is from 5 to 500 mg/m²; the coating covers at least 90% of the surface of the metal, when measured as described below; and the coating comprises, preferably consists essentially of, or more preferably consists of, (optionally with other specific materials as specified further below) polymer molecules that comprise, preferably consist essentially of, or more preferably, except for end groups, consist of, structural units conforming to general formula (I):

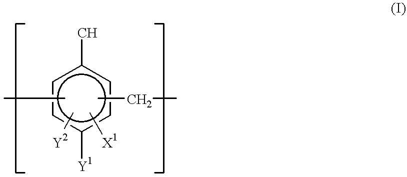

in which:

X¹ in each structural unit is a hydrogen atom or a moiety Z¹ conforming to general formula (II):

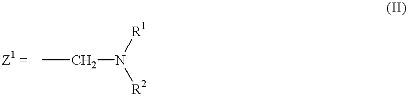

in which each of R¹ and R² is a hydrogen atom, a C₁ to C₁₀ monovalent alkyl moiety, or a C₁ to C₁₀ monovalent hydroxyalkyl moiety;

Y¹ is one of: a hydrogen atom; a hydroxyl moiety; a monovalent C₁ to C₅ alkyl moiety; a monovalent C₁ to C₅ hydroxyalkyl moiety; a monovalent C₆ to C₁₂ aryl, benzyl, or benzo moiety; or a moiety conforming to general formula (III):

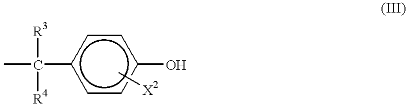

in which, independently for each unit according to general formula (I) in which Y¹ conforms to general formula (III), each of R³ and R⁴ is independently a hydrogen atom, a monovalent C₁ to C₁₀ alkyl moiety, or a monovalent C₁ to C₁₀ hy-droxyalkyl moiety, and X² is a hydrogen atom or a moiety Z² conforming to general formula (IV):

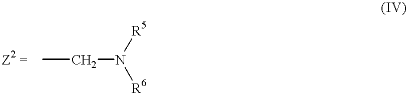

in which each of R⁵ and R⁶ is independently a hydrogen atom, a mono-valent C₁ to C₁₀ alkyl moiety, or a monovalent C₁ to C₁₀ hydroxyalkyl moiety;

or Y¹ and Y² are bonded to each other and to adjacent carbon atoms in the aromatic ring shown in general formula (I) so as to constitute from Y¹, Y², and the aromatic ring shown in general formula (I) a naphthyl or alkyl substituted naphthyl moiety; and

Y² is a hydrogen atom unless it is bonded to Y¹ to constitute part of a naphthyl moiety as described above;

said polymer molecules that comprise, preferably consist essentially of, or more preferably, except for end groups, consist of structural units conforming to general formula (I), having a total number of Z¹ and Z² moieties and a distinct (but not necessarily unequal) total number of units conforming to general formula (I) and Y¹ moieties that conform to general formula (III), such that the total number of Z¹ and Z² moieties has a ratio to the total number of units conforming to general formula (I) and Y¹ moieties that conform to general formula (III) that is from 0.2:1.0 to 1.0:1.0. As an example, when the polymer contains 100 structural units with formula (I) and 100 total Z¹ and Z² moieties are present in this polymer, this ratio will be 1.0 when none of the Y¹ moieties corresponds to general formula (III) and will be 0.5 when every Y¹ moiety corresponds to general formula (III).

### DETAILED DESCRIPTION OF THE INVENTION

Y¹ in general formula (I) is preferably a group conforming to general formula (III), because this provides an increased adherence between the laminated film and the metal.

In addition, phosphoric acid-type compounds and/or organosilicon compounds are preferably present in the coating on the subject coated metal, because this also provides an increased adherence between the laminated film and the metal.

The coating under discussion can be executed on the metal as a reactive coating or a dry-in-place coating. “Reactive” denotes treatment in which reaction is effected with the metal surface, the residual unreacted aqueous liquid composition, hereinafter often called “bath” for brevity, even if contacted with the surface by some method such as spraying, on the surface is then removed by a water rinse, and the metal is thereafter dried. “Dry-in-place” denotes treatment in which bath is applied to the metal surface followed by drying without an intervening water rinse.

A process according to the present invention for preparation of the reactively coated metal comprises steps of:

(I) providing a waterborne composition comprising water and at least 0.1 g/L of the above-described polymer comprising units according to general formula (I) and, optionally, at least one selection from phosphoric acid-type compounds and organosilicon compounds, said waterborne composition having a pH in a range from 2.5 to 6.5, the total concentration of one or more selections from phosphoric acid-type compounds and organosilicon compounds preferably being at least 0.1 g/L;

(II) forming a coating for film lamination on a surface of a metal by contacting and reacting the surface of the metal with said waterborne composition; and

(III) after step (II), rinsing the metal surface with water and thereafter drying the metal surface.

A process according to the present invention for the preparation of a dry-in-place coated metal comprises steps of:

(I′) preparing a waterborne composition comprising water and at least 0.01 g/L of the above-described polymer comprising units according to general formula (I) and, optionally, one or more selections from phosphoric acid-type compounds and organosilicon compounds, said waterborne composition having a pH in a range from 2.5 to 6.5, the total concentration of one or more selections from phosphoric acid-type compounds and organosilicon compounds preferably being at least 0.1 g/L; and

(II′) forming a coating for film lamination on a surface of a metal by application of said waterborne composition to the surface of the metal, and then drying the metal surface.

The metal substrate to be coated according to the present invention is not critical, but in industrial applications will mainly be iron or steel stock or aluminum stock. The shape of the metal is also not critical and is exemplified by shapes that facilitate and support film lamination, such as plate, disk, sheet, and coil shapes.

X¹ in formula (I) for the polymer used for the coated metal according to the present invention is, as specified above, independently selected for each structural unit from the hydrogen atom and groups Z¹ with formula (II). R¹ and R² in formula (II) are independently a hydrogen atom, a C₁ to C₁₀ alkyl moiety, or a C₁ to C₁₀ hydroxyalkyl moiety. Alkyl and hydroxyalkyl having 11 or more carbons usually cause the functional group to be too bulky and result in a coarsening of the coating and hence a decline in the corrosion resistance. More preferably, at least in part for reasons of economical commercial availability, these alkyl moieties and hydroxyalkyl moieties have not more than, with increasing preference in the order given, 8, 6, 4, 3, or 2 carbon atoms each.

As specified above, Y¹ in general formula (I) may be a hydrogen atom, a hydroxyl moiety, a C₁ to C₅ alkyl moiety, a C₁ to C₅ hydroxyalkyl moiety, a C₆ to C₁₂ aryl, benzyl, or benzo moiety, or a moiety conforming to general formula (III). In addition Y¹ and Y² can together form a naphthyl moiety that includes the carbon atoms of the aromatic ring shown in formula (I). Alkyl and hydroxyalkyl moieties having 6 or more carbons and aryl moieties having 13 or more carbons usually cause the resin to become bulky and develop steric hindrance and thereby prevent the coating from assuming the fine, dense configuration that exhibits excellent corrosion resistance and excellent adherence. More preferably, at least in part for reasons of economical commercial availability, these alkyl and hydroxyalkyl moieties have not more than, with increasing preference in the order given, 8, 6, 4, 3, or 2 carbon atoms each. Y¹ is preferably a group with formula (III) for the good adherence this favors.

If the total number of Z¹ and Z² moieties has a ratio to the total number of units conforming to general formula (I) and Y¹ moieties that conform to general formula (III) that is less than 0.2, the resin normally will not exhibit an acceptable adherence to the metal and the film will readily debond during working operations. Preferably, in order to more thoroughly avoid any difficulties with the adhesion of the resin to either the film or the metal, this ratio is at least 0.5. A value for this ratio in excess of 1.0:1.0 usually causes an excessive bulkiness and hence a coarse coating and a reduced corrosion resistance.

The usual methods can be used to prepare the polymer (I) that makes up at least part of the coating on the coated metal according to the present invention. For example, polymer conforming to general formula (I) can be synthesized by polycondensing formaldehyde with a phenol, naphthol, or bisphenol (e.g., bisphenol-A or -F) and then introducing the X¹ and X² functional groups using formaldehyde and amine. The usual grades of formalin can be used as the formaldehyde.

While the molecular weight of this polymer is not critical, its molecular weight will generally be from 1,000 to 1,000,000, preferably from 1,000 to 100,000, and particularly preferably from 1,000 to 10,000. The molecular weight can be measured by gel permeation chromatography on the peeled-off coating.

As discussed above, a phosphoric acid-type compound and/or an organosilicon compound is preferably present in the coating on the coated metal according to the present invention, because this provides an improved adherence between the laminated film and metal.

Phosphoric acid-type compounds usable for this purpose are exemplified by metaphosphoric acid and its salts, orthophosphoric acid and its salts, condensed phosphoric acids, i.e., acids conforming to the general formula H₍ₚ₊₂₎PₚO₍₃ₚ₊₁₎, where p is a positive integer with a value of at least 2, preferably 2 or 3, the salts of any of these acids, and stable colloidal dispersions of zirconium phosphate and titanium phosphate(s) in water. The salts are exemplified by the ammonium salts and by the alkali metal salts such as the sodium and potassium salts.

The organosilicon compounds are preferably selected from silanes conforming to general formula (V):

(YR)ₘRₙSiX₍₄₋ₘ₋ₙ₎ (V),

in which R denotes an alkyl moiety, which may be the same or different from one of the m YR and the n R moieties to another; X denotes a methoxy or ethoxy moiety; Y denotes a moiety selected from the group consisting of vinyl, amino, mercapto, and glycidoxy, and methacryloxy moieties, which may be the same or different from one of the m YR moieties to another; m is an integer with a value from 1 to 3; and n is an integer with a value of 0 to (3-m). Such silanes are exemplified by vinylethoxysilane, y-aminopropyltri-ethoxysilane, N-(β-aminoethyl)-y-aminopropyltriethoxysilane, y-mercaptopropyltrimeth-oxysilane, y-glycidoxypropyltrimethoxysilane, and y-methacryloxypropyltrimethoxysilane.

The add-on mass per unit area of the phosphoric acid-type compound, measured as its stoichiometric equivalent as phosphorus, relative to the metal must be at least 0.1 mg/m² in order to achieve the benefit specified above for the addition of this ingredient. The add-on preferably does not exceed 200 mg/m². An increase in the adherence of the laminated film is not observed at an add-on below 0.1 mg/m², while add-ons in excess of 200 mg/m² are costly. The add-on mass per unit area coated of the organosilicon compound, measured as its stoichiometric equivalent as silicon, relative to the metal must be at least 0.1 mg/m² in order to achieve the benefits specified above for the addition of this ingredient. The add-on of silicon preferably does not exceed 100 mg/m². Little if any increase in adherence is observed at an add-on below 0.1 mg/m², while add-ons in excess of 100 mg/m² are costly.

The phosphorus add-on and silicon add-on can be determined using commercially available fluorescent x-ray analyzers. Specifically, a plurality of samples bearing known but different phosphorus (or silicon) add-ons are measured and the corresponding intensity-versus-add-on calibration curve is constructed from the measured intensities in counts per second (hereinafter usually abbreviated as “cps”). A sample is then cut from the coated metal according to the present invention and measured under the same conditions as in calibration. The measured intensity is converted to add-on using the calibration curve.

The coating on the coated metal according to the present invention must exhibit a thickness of 5 to 500 nm, preferably has a thickness of 15 to 300 nm, and more preferably of 50 to 300 nm. An excellent adherence by the laminated film is not obtained at coating thicknesses below 5 nm, while exceeding 500 nm has a high potential for impairing the color of the metal. The overall coating weight of the coating must include 5 to 500 mg as carbon per m² and is preferably from 50 to 200 mg/m². An excellent adherence is not obtained when the total coating weight is below 5 mg/m², while exceeding 500 mg/m² has a high potential for impairing the color of the metal.

The carbon add-on can be measured using commercially available surface carbon analyzers. Specifically, the coated metal according to the present invention is first cut to a suitable size (about 20 to 50 cm²) to provide the sample. Surface carbon analyzers operate by heating the sample in order to oxidize and volatilize the carbon present on the surface and measuring the resulting gas using infrared (hereinafter usually abbreviated as “IR”) absorption. While any measurement conditions can be used that result in oxidation and volatilization of the surface carbon, measurement is ordinarily preferably run at 400° C. to 500° C. for 5 to 10 minutes.

In addition, the coating on the coated metal according to the present invention must cover at least 90% of the metal surface. The film has a strong tendency to debond during working operations at coverage ratios below 90%.

The coating thickness and coverage ratio can be measured using commercially available x-ray photoelectron spectroscopic analysis (hereinafter usually abbreviated as “XPS”) instruments. In an XPS instrument, the sample is excited by X-rays under an ultrahigh vacuum, i.e., a pressure ≦10⁻⁵ Pascal) and the emitted photoelectrons are analyzed. The proportions of the atoms present in the surface can be determined from the intensity of the photoelectrons and a sensitivity factor. The methods for carrying out the quantitative calculation of coating thickness and coverage ratio have already been established and are available as commercial software.

Measurement of the coverage ratio will be considered first. Samples exposed to the atmosphere will inevitably be contaminated. Thus, XPS analysis of a sample cleaned in the atmosphere will detect contaminants such as carbon in the outermost surface. In order to eliminate this interference, in the present invention analysis for determination of the coverage ratio was carried out after a moderate sputtering with argon that removed 2 nm of the outermost surface. In sequence, the surface was first sputtered, using a commercial argon sputtering gun attached to the XPS analyzer, in order to remove contaminants, the surface was then excited by X-rays, and the photo-electron emission was analyzed. After X-ray excitation, a so-called wide-scan analysis was run in order to qualitate the atoms present in the surface. In the present invention the elements generally detected in analysis of the coating were mainly carbon, oxygen, phosphorus, silicon, zirconium, titanium, and the elements in the metal stock (iron, aluminum). Quantitative calculation was carried out on the qualitatively measured elements and a value “A”, the total atomic % for the atoms constituting the metal substrate, was determined from this. The coverage ratio percentage was defined to be 100-A.

The coating thickness was then measured using the argon sputtering gun. The coating thickness was first measured on a plural number of samples having different but known coating thicknesses that had been measured using a transmission electron microscope. Each of these samples was repeatedly subjected to argon sputtering followed by photoelectron analysis. The coating was assumed to be present until the coverage ratio reached 40%. A calibration curve was constructed from the known coating thicknesses and the total time required in each case for sputtering to the end point. In the subsequent analyses of samples of coated metal according to the present invention, the coating thickness was determined from the calibration curve using the total sputtering time to reach a coverage ratio of 40%.

Methods for the preparation of the coated metal according to the present invention will now be considered in detail.

The surface of the metal stock normally must be cleaned before fabrication of the coated metal according to the present invention comprising metal bearing a coating for film lamination. Thus, industrial metal stock normally carries rolling oil or is coated with rust-preventive oil, and these oils must be removed, by a process generally known as degreasing. The degreasing technique is not critical, and solvent degreasers, alkaline degreasers, and acidic degreasers in general use as known to those skilled in the art can be used for this purpose.

The pH of a composition according to this invention is preferably 3.0 to 5.0. A satisfactory coating formation does not usually occur at a pH below 2.5, while problems with the stability of the waterborne composition often occur at a pH above 6.5. The pH can be adjusted as necessary using sodium hydroxide or an acid such as phosphoric acid, condensed phosphoric acid, hydrofluoric acid, etc., and particularly mineral acids. The acids function as etchants. The etching efficiency can be increased through the use of peroxide and the like as an etching assistant.

The concentration of polymer comprising units that conform to general formula (I) must be at least 0.1 g/L, is preferably from 0.1 to 10 g/L, and more preferably is from 0.3 to 3 g/L. A satisfactory coating formation does not occur when the polymer concentration is less than 0.1 g/L, while high costs, without adequately corresponding benefits, are incurred when the polymer concentration exceeds 10 g/L. The concentration of the one or more selections from phosphoric acid-type compounds and organosilicon compounds preferably is at least 0.1 g/L, is more preferably from 0.1 to 30 g/L, and still more preferably is from 0.3 to 1 g/L. The reactivity may be undesirably low when the concentration of the one or more selections from phosphoric acid-type compounds and organosilicon compounds is below 0.1 g/L, while high costs, without adequately corresponding benefits, are incurred when this concentration exceeds 30 g/L.

The technique for effecting contact between the waterborne composition and the metal is not critical. Contact is normally effected by spraying the metal surface with the waterborne composition or dipping the metal in the waterborne composition. The temperature of the waterborne composition during this treatment is not critical, but is generally preferably from 40° C. to 60° C. When spraying is used, the metal is preferably allowed to stand for about 1 to 30 seconds after spraying. When dipping is used, the dipping time is preferably from about 1 to 30 seconds. During this contact the surface of the metal is etched and a local increase in pH occurs at the interface. This results in coating due to deposition of the polymer on the surface. When a reactive coating is being formed, unreacted bath is ordinarily removed by rinsing with water after the contact phase. The coating is usually then dried. While the drying temperature is not critical, drying temperatures of 60° C. to 200° C. are ordinarily preferred. Drying is generally effected using a hot gas flow; air is generally the most economical and readily available gas for this purpose.

The coating thickness, coating weight, coverage ratio, phosphoric acid-type compound add-on, and organosilicon compound add-on for the dried coating are adjusted if necessary into the above-specified ranges in the coated metal according to the present invention. These adjustments can be accomplished by varying such parameters as the concentrations of the polymer, etchant, phosphoric acid-type compound, and organosilicon compound in the waterborne composition, the treatment temperature, the treatment time, and so forth.

The advantages to reactive coating are that it affords very uniform coatings and achieves high coverage ratios at low coating thicknesses.

For dry-in-place coating in a process according to the invention, the concentration of polymer comprising units conforming to general formula (I) is preferably from 0.01 to 10 g/L and more preferably is from 0.1 to 2 g/L. A satisfactory add-on is not obtained when the polymer concentration is less than 0.01 g/L, while high costs, without adequately corresponding benefits, are incurred when the polymer concentration exceeds 10 g/L. The concentration of the one or more selections from phosphoric acid-type compounds and organosilicon compounds preferably is at least 0.01 g/L, is more preferably from 0.01 to 30 g/L, and still more preferably is from 0.05 to 3 g/L. The add-on may be inadequate when the concentration of the one or more selections from phosphoric acid-type compounds and organosilicon compounds is below 0.01 g/L, while high costs, without adequately corresponding benefits, are incurred when this concentration exceeds 30 g/L.

Unlike the case of reactive coating, the waterborne composition can have any pH in the case of dry-in-place coating and the pH is therefore not critical. However, a pH from 3 to 6 will generally be suitable.

The technique for applying the waterborne composition to the metal surface is not critical in the case of dry-in-place coating, but in general the waterborne composition will be applied to the metal surface using, for example, a roll coater. The temperature of the waterborne composition during application is not critical, but temperatures from 15° C. to 35° C. are generally preferred. The coating is usually then dried. The drying temperature is again not critical, but temperatures from 80° C. to 200° C. are generally preferred. Drying will generally be carried out using a hot gas flow, with air again normally the most economical and readily available gas for this purpose.

The coating thickness, coating weight, coverage ratio, phosphoric acid-type compound add-on, and organosilicon compound add-on for the dried coating are adjusted if needed into the above-specified ranges in the coated metal according to the present invention. These adjustments can be accomplished by adjusting such parameters as the concentrations of the polymer, phosphoric acid-type compound, and organosilicon compound in the waterborne composition and the application temperature.

The advantage to dry-in-place coating is that this treatment can be run as one element in a continuous process. In other words, dry-in-place coating formation can be run as a pre-treatment when film lamination is being run as a continuous process.

The same methods used for film lamination on prior-art coated metals bearing a chromium-type coating can be used for film lamination on coated metal according to the present invention bearing on its surface a coating for film lamination generated as described above.

The nature of the laminated film is not critical, and conventional lamination films as referenced in the preceding description of the prior art can be used. The film is specifically exemplified by thermoplastic resin films, e.g., polyethylene films, polycarbonate films, and polyester films and particularly films composed mainly of polymers of vinyl terephthalate. The shape of the lamination film is not critical, but in general plate-shaped films or sheet-form films will be used. While the film lamination technology is not critical, lamination is typically carried out by heating and softening the film. The use of adhesive at this point is not generally necessary, but an adhesive may be used as desired.

Several examples of the coating according to the present invention are provided below. Moreover, the utility of these coatings is described relative to comparative examples.

### Substrate Metals and Cleaning Processes Used

1. Aluminum Alloy Sheet

The surface of commercial aluminum-manganese alloy sheet (Japanese Industrial Standard, hereinafter usually abbreviated as “JIS”, type A3004, sheet thickness=0.3 mm, dimensions=200×300 mm) was cleaned by spraying for 20 seconds at 75° C. with an 8% aqueous solution of a commercial acidic cleaner (PALKLINO® 500 from Nihon Parkerizing Company, Limited). This was followed by a water rinse.

2. Steel Sheet

The surface of commercial cold-rolled steel sheet (JIS type SPCC, sheet thickness =0.3 mm, dimensions=200×300 mm) was cleaned by spraying for 20 seconds at 60° C. with a 2% aqueous solution of a commercial cleaner (Fine Cleaner 4328 from Nihon Parkerizing Company, Limited). This was followed by a water rinse.

### Production of the Coated Metals

The aluminum alloy or steel sheet was coated as described in the particular example or comparative example to form thereon a reactive coating or a dry-in-place coating.

### Measurement of the Carbon Add-On

The carbon add-on (mg/m²) by the coating was measured using a commercial surface carbon analyzer from LECO. The sample size was 32 cm² and the measurement conditions were 400° C. for 8 minutes.

### Coverage Ratio and Coatinc Thickness

The status of the coating was analyzed using a commercial XPS (X-ray photo-electron spectroscopic analysis) instrument from Shimadzu. Mg was used as the X-ray source at conditions of 8 kilovolts and 30 milliamperes (hereinafter usually abbreviated as “mA”). The sample size was a circle 5 mm in diameter. Qualitative analysis was carried out after a 2 nm sputtering of the outermost surface. The detected elements were quantitatively calculated and the coverage ratio was then calculated as described above. A commercial argon sputtering gun (Shimadzu) was attached to the XPS instrument and the coating was destroyed and removed by sputtering. The sputtering conditions were 600 volts and 50 milliamperes. The coating thickness (nm) was determined from the sputtering time using the method described above.

### Film Lamination and Forming

The coated metal was laminated with polyester film (thickness=30 μm) at 180° C. and then punched to form a circular disk 140 mm in diameter, and this was drawn to give a cup. The cup was subsequently re-drawn and ironed using a three-piece die to give the draw-ironed can.

### Performance Evaluation of the Film-Laminated Coated Metal

1. Formability

The draw-ironing process was evaluated on the following scale.

×: rupture

Δ: scarring without rupture

+: no scarring, no rupture

2. Corrosion Resistance

The leakage current was measured on the draw-ironed can body using a commercial enamel rater from the Peco Company. The measurement liquid was 0.5% saline, and the current value, at 6.3 volts potential difference, was measured after 4 seconds. Lower current values are desirable. The results were scored on the following scale.

+: less than 0.3 mA

Δ: at least 0.3 mA, but less than 1.0 mA

×1.0 mA or more

3. Adherence

The draw-ironed can body was retorted, i.e., heated in steam under pressure, in a commercial sterilizer at 121° C. for 30 minutes. The adherence was evaluated on the following scale based on the post-retorting adherence of the film.

+: debonding from the substrate completely absent

Δ: partial debonding

×: debonding over the entire surface

4. Environmental Safety

The use of hexavalent chromium, which is toxic to humans, during formation of the coating was scored with the symbol x, while the non-use of hexavalent chromium was scored with the symbol +.

### Example 1

A dry-in-place coating was produced by applying the Waterborne Composition 1 described below to the aluminum alloy sheet specified above and then drying the coating at 80° C.

Waterborne Composition 1

| | | |
|---|---|---|
| Water Soluble Polymer 1 solids | 2.0 | g/L |
| pH 6.0 (adjusted with phosphoric acid) | | |

### Water Soluble Polymer 1

This was a polymer consisting entirely, except for short end groups, of units represented by formula (I) when: X¹ in each structural unit conforming to general formula (I) was a hydrogen atom or a moiety —CH₂N(CH₃)₂, corresponding to Z¹; Y¹ and Y² each represents a hydrogen atom; and the average ratio of Z¹ moieties to benzene rings was 0.5:1.0. The polymer had a weight average molecular weight of 3,000.

### Example 2

A dry-in-place coating was produced by applying Waterborne Composition 2 described below to the aluminum alloy sheet specified above and then drying the coating at 80° C.

Waterborne Composition 2

| | | |
|---|---|---|
| Water Soluble Polymer 2 solids | 0.5 | g/L |
| pH 6.0 (adjusted with phosphoric acid) | | |

### Water Soluble Polymer 2

This was a polymer consisting entirely, except for short end groups, of units represented by formula (I) when: X¹ in each structural unit conforming to general formula (I) was a hydrogen atom or a moiety —CH₂N(CH₃)₂, corresponding to Z¹; Y¹ conformed to general formula (III) when: X² represents a hydrogen atom or a moiety —CH₂N(CH₃)₂, corresponding to Z²; Y² represents a hydrogen atom; and the average ratio of the total —CH₂N(CH₃)₂ moieties, corresponding to Z¹+Z², to benzene rings was 1.0:1.0. The polymer had a weight average molecular weight of 1,500.

### Example 3

A reactive coating was produced by spraying Waterborne Composition 3 for 20 seconds at a composition temperature of 50° C. onto the aluminum alloy sheet specified above, rinsing the surface with water and then deionized water, and then drying the coating at 80° C.

Waterborne Composition 3

| | | |
|---|---|---|
| HF | 0.05 | g/L |
| H₃PO₄ | 2.0 | g/L |
| Na₄P₂O₇ · 10H₂O | 2.0 | g/L |
| Water Soluble Polymer 3 solids | 5.0 | g/L |
| pH 4.0 (adjusted with sodium hydroxide) | | |

### Water Soluble Polymer 3

This was a polymer consisting entirely, except for short end groups, of units conforming to formula (I) when X¹ is a hydrogen atom or a moiety —CH₂N(CH₂CH₂OH)₂, corresponding to Z¹; Y¹ conforms to general formula (III) when X² is a hydrogen atom or a moiety —CH₂N(CH₂CH₂OH)₂, corresponding to Z²; Y² represents a hydrogen atom; and the average ratio of Z¹+Z² moieties to benzene rings is 0.75:1.0. The polymer had a weight average molecular weight of 5,000.

### Example 4

A reactive coating was produced by dipping the aluminum alloy sheet specified above in Waterborne Composition 4 for 4 seconds at a composition temperature of 60° C., rinsing the surface with water and then deionized water, and then drying the coating at 80° C.

Waterborne Composition 4

| | | |
|---|---|---|
| HF | 0.05 | g/L |
| H₂O₂ | 1.0 | g/L |
| H₃PO₄ | 2.0 | g/L |
| Na₄P₂O₇ · 10H₂O | 2.0 | g/L |
| Water Soluble Polymer 4 solids | 5.0 | g/L |
| pH 3.5 (adjusted with sodium hydroxide) | | |

### Water Soluble Polymer 4

This was a polymer consisting entirely, except for short end groups, of units conforming to formula (I) when: X¹ is a hydrogen atom or a moiety —CH₂N(CH₂CH₂CH₂OH)(CH₃), corresponding to Z¹; Y¹ conforms to general formula (III) when X² is a hydrogen atom or a moiety —CH₂N(CH₂CH₂CH₂OH)(CH₃), corresponding to Z²; Y² represents a hydrogen atom; and the average ratio of Z¹+Z² moieties per benzene ring is 0.5:1.0. The polymer had a weight average molecular weight of 7,500.

### Example 5

A dry-in-place coating was produced by applying the Waterborne Composition 5 described below to the steel sheet specified above and then drying the coating at 80° C.

Waterborne Composition 5

| | | |
|---|---|---|
| Water Soluble Polymer 1 solids | 2.0 | g/L |
| H₂ZrF₆ | 0.1 | g/L |
| H₃PO₄ | 0.1 | g/L |
| pH 6.0 (adjusted with aqueous ammonia) | | |

### Example 6

A dry-in-place coating was produced by applying the Waterborne Composition 6 described below to the steel sheet specified above and then drying the coating at 80° C.

Waterborne Composition 6

| | | |
|---|---|---|
| Water Soluble Polymer 3 solids | 2.0 | g/L |
| H₂ZrF₆ | 0.1 | g/L |
| H₃PO₄ | 0.1 | g/L |
| y-glycidoxypropyltrimethoxysilane | 0.05 | g/L |
| pH 6.0 (adjusted with aqueous ammonia) | | |

### Example 7

A reactive coating was produced by dipping the steel sheet specified above in Waterborne Composition 7 for 10 seconds at a composition temperature of 60° C., rinsing the surface with water and then deionized water, and then drying the coating at 80° C.

Waterborne Composition 7

| | | |
|---|---|---|
| HF | 0.10 | g/L |
| H₂O₂ | 2.0 | g/L |
| H₃PO₄ | 2.0 | g/L |
| Na₄P₂O₇ · 10H₂O | 2.0 | g/L |
| Water Soluble Polymer 3 solids | 5.0 | g/L |
| pH 4.0 (adjusted with sodium hydroxide) | | |

### Comparative Example 1

A coating was produced by spraying the above-specified aluminum alloy sheet for 10 seconds at a solution temperature of 50° C. with a 4% aqueous solution of a commercial phosphate-chromate conversion agent (ALCHROME® K 702 from Nihon Parkerizing Company, Limited) followed by rinsing the surface with water and then deionized water and then drying the coating at 80° C.

### Comparative Example 2

A coating was produced by spraying the above-specified aluminum alloy sheet for 10 seconds at a solution temperature of 40° C. with a 2% aqueous solution of a commercial zirconium-type conversion agent (ALODINE® N 405 from Nihon Parkerizing Company, Limited) followed by rinsing the surface with water and then deionized water and then drying the coating at 80° C.

### Comparative Example 3

A coating was produced by applying the Waterborne Composition 8 described below to the steel sheet specified above and then drying the coating at 80° C.

Waterborne Composition 8

| | | |
|---|---|---|
| H₂ZrF₆ | 0.1 | g/L |
| H₃PO₄ | 0.1 | g/L |
| y-glycidoxypropyltrimethoxysilane | 0.05 | g/L |
| pH 6.0 (adjusted with aqueous ammonia) | | |

### Comparative Example 4

Commercial TFS on which a chromium-type coating had been executed was used.

Table 1 below reports the coating thickness, carbon add-on, and coverage ratio for the coated metals prepared in Examples 1 to 7 and Comparative Examples 1 to 4.

TABLE 1

| Example | | | | | | | |
|---|---|---|---|---|---|---|---|
| (“Ex”) | | | Characteristics of the Coating | | | | |
| or Com- | | | Formed During Treatment | | | | |
| parison | Treatment | | | Carbon | | Optional Element | |
| Example | Characteristics | | Coating | Add-On | Cover- | Add-On Masses, | |
| (“CE”) | Sub- | Contact | Thick- | Mass, | age | mg/m², for: | |
| Number | strate | Method | ness, nm | mg/m² | Ratio, % | P | Si |
| Ex 1 | Al | dry-in-place | 200 | 200 | 96 | 5 | 0 |
| Ex 2 | Al | dry-in-place | 100 | 100 | 90 | 5 | 0 |
| Ex 3 | Al | reactive | 20 | 20 | 95 | 3 | 0 |
| Ex 4 | Al | reactive | 30 | 30 | 97 | 3 | 0 |
| Ex 5 | steel | dry-in-place | 250 | 250 | 95 | 10 | 0 |
| Ex 6 | steel | dry-in-place | 250 | 250 | 95 | 5 | 2 |
| Ex 7 | steel | reactive | 15 | 15 | 90 | 2 | 0 |
| CE 1 | Al | reactive | 50 | 2*¹ | 85 | 10 | 0 |
| CE 2 | Al | reactive | 25 | 2*¹ | 85 | 5 | 0 |
| CE 3 | steel | dry-in-place | 100 | 2*¹ | 80 | 4 | 1 |
| CE 4 | TFS | none | — | 2*¹ | — | 0 | 0 |

Footnotes for Table 1
*¹Detection originating with surface contamination from the atmosphere.

Table 2 reports the results from the performance evaluations of the coated metals. As the results in Table 1 make clear, the coated metals in Examples 1 to 7 cording to the present invention gave excellent results over the entire property spectrum (formability, corrosion resistance, adherence, and environmental safety). In contrast to this, the property spectrum was not satisfied in its entirety by any of the comparative examples, i.e., Comparative Example 1 in which the coated metal carried a phosphatechromate coating, Comparative Example 2 in which the coated metal carried a zirconium-type coating, Comparative Example 3 in which the coated metal carried a coating that did not contain the polymer used by the present invention, and Comparative Example 4, in which the substrate was precoated TFS.

TABLE 2

| | Performance Rating for: | | | |
|---|---|---|---|---|
| Example (“Ex”) or Com- | | | | Environ- |
| parison Example (“CE”) | | Corrosion | Ad- | mental |
| Number | Formability | Resistance | herence | Safety |
| Ex 1 | + | + | + | + |
| Ex 2 | + | + | + | + |
| Ex 3 | + | + | + | + |
| Ex 4 | + | + | + | + |
| Ex 5 | + | + | + | + |
| Ex 6 | + | + | + | + |
| Ex 7 | + | + | + | + |
| CE 1 | Δ | x | x | x |
| CE 2 | x | *² | *² | + |
| CE 3 | x | *² | *² | + |
| CE 4 | + | + | + | x |

Footnotes for Table 2
*²No can could be formed. Because the corrosion resistance and adherence tests were performed only on finished cans, the values for these columns in these comparative experiments therefore could not be obtained.

### Benefits of the Invention

The coated metal according to the present invention has an excellent formability, excellent corrosion resistance, excellent adherence, and excellent environmental safety.

1. A coated metal article having on its surface a coating suitable for film lamination thereon, wherein:
said coating has a thickness that is from 5 to 500 nm;
said coating has a content of carbon atoms that corresponds to from 5 to 500 mg/m² of the coating area;
said coating covers at least 90% of the surface of the metal; and
said coating comprises polymer molecules that comprise units conforming to general formula (I): 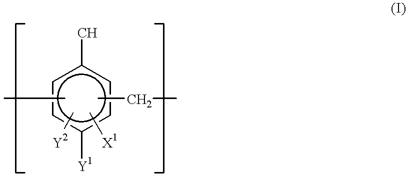
in which:
X¹ independently in each structural unit is a hydrogen atom or a moiety Z¹ conforming to general formula (II): 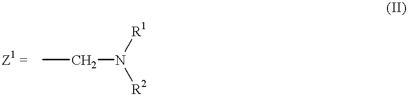
in which each of R¹ and R² independently is a hydrogen atom, a C₁to C₁₀ monovalent alkyl moiety, or a C₁ to C₁₀ monovalent hydroxyalkyl moiety;
Y¹, independently for each unit, is a hydrogen atom, a hydroxyl group, a C₁ to C₅ alkyl moiety, a C₁ to C₅ hydroxyalkyl moiety, a C₆ to C₁₂ aryl, benzyl, or benzo moiety, or a moiety conforming to general formula (III): 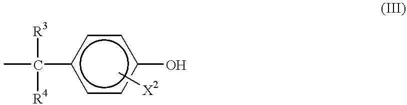
in which, independently for each unit according to general formula (I) in which Y¹ conforms to general formula (III), each of R³ and R⁴ is independently a hydrogen atom, a C₁ to C₁₀ alkyl moiety, or a C₁ to C₁₀ hydroxyalkyl moiety, and X² is a hydrogen atom or a moiety Z² conforming to general formula (IV): 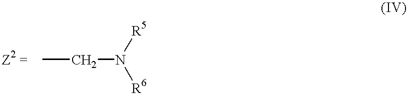
in which each of R⁵ and R⁶ is independently a hydrogen atom, a C₁ to C₁₀ alkyl moiety, or a C₁ to C₁₀ hydroxyalkyl moiety; and
Y², independently for each unit, is a hydrogen atom or, when Y¹ and Y² are bonded to adjacent carbon atoms in the aromatic ring shown in general formula .(I), Y¹, Y², and said adjacent carbon atoms to which Y¹ and Y² are bonded together may constitute a condensed benzene ring,
said polymer molecules that comprise structural units conforming to general formula (I) having a total number of Z¹ and Z² moieties and a distinct (but not necessarily unequal) total number of (i) units conforming to general formula (I) and (ii) Y¹ moieties that conform to general formula (III), such that the total number of Z¹ and Z² moieties has a ratio to the total number of units conforming to general formula (I) and Y¹ moieties that conform to general formula (III) that is from 0.2:1.0 to 1.0:1.0.

2. A coated metal article according to claim 1, in which Y¹ in general formula (I) conforms to general formula (III).

3. A coated metal article according to claim 2, in which the coating comprises a total of at least 0.1 mg/m² of phosphorus atoms present in phosphoric acid like compounds and silicon atoms present in organosilicon compounds.

4. A coated metal article according to claim 1, in which the coating comprises a total of at least 0.1 mg/m² of phosphorus atoms present in phosphoric acid like compounds and silicon atoms present in organosilicon compounds.

5. A coated metal article according to any one of claims 1 through 4, wherein:
said coating has a thickness in a range from 50 to 300 nm; and
said coating has a content of carbon atoms that corresponds to from 50 to 200 mg/m² of the coating area.

6. A process for providing a surface of a metal substrate with a coating suitable for laminating film thereto, said process comprising steps of:
(I) providing a waterborne composition that comprises water and:
(A) at least 0.01 g/L of polymer molecules comprising units conforming to general formula (I): 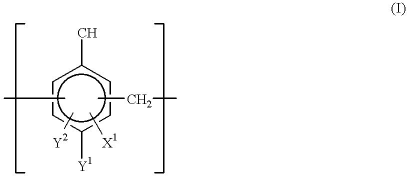
in which:
X¹, independently in each structural unit, is a hydrogen atom or a moiety Z¹ conforming to general formula (II): 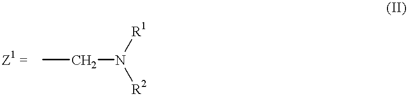
in which each of R¹ and R² independently is a hydrogen atom, a C₁ to C₁₀ monovalent alkyl moiety, or a C₁ to C₁₀ monovalent hydroxyalkyl moiety;
Y¹, independently in each structural unit, is a hydrogen atom, a hydroxyl group, a C₁ to C₅ alkyl moiety, a C₁ to C₅ hydroxyalkyl moiety, a C₆ to C₁₂ aryl, benzyl, or benzo moiety, or a moiety conforming to general formula (III): 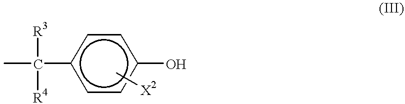
in which, independently for each unit according to general formula (I) in which Y¹ conforms to general formula (III), each of R³ and R⁴ is independently a hydrogen atom, a C₁ to C₁₀ alkyl moiety, or a C₁ to Cl₁₀ hydroxyalkyl moiety, and X² is a hydrogen atom or a moiety Z² conforming to general formula (IV): 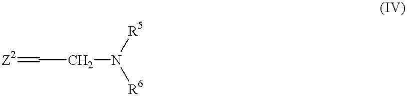
in which each of R⁵ and R⁶ is independently a hydrogen atom, a C₁ to C₁₀ alkyl moiety, or a C₁ to C₁₀ hydroxyalkyl moiety; and
Y², independently in each structural unit, is a hydrogen atom or, when Y¹ and Y² are bonded to adjacent carbon atoms in the aromatic ring shown in general formula (I), Y¹, Y², and said adjacent carbon atoms to which Y¹ and Y² are bonded together may constitute a condensed benzene ring,
said polymer molecules that comprise structural units conforming to general formula (I) having a total number of Z¹ and Z² moieties and a distinct (but not necessarily unequal) total number of (i) units conforming to general formula (I) and (ii) Y¹ moieties that conform to general formula (III), such that the total number of Z¹ and Z² moieties has a ratio to the total number of units conforming to general formula (I) and Y¹ moieties that conform to general formula (Ill) that is from 0.2:1.0 to 1.0:1.0; and, optionally, at least one of the following components:
(B) phosphoric acid-type compounds; and
(C) organosilicon compounds, said waterborne composition having a pH in a range from 2.5 to 6.5;
(II) contacting said surface of said metal substrate with the waterborne composition provided in step (I) for a sufficient time at a sufficient temperature to form a solid coating containing constituents of said waterborne composition, said solid coating adhering to said surface of said metal substrate and being itself covered, at least initially; by a coating of liquid; and
(III) after step (II), drying the metal surface so as to remove from the metal surface the liquid constituents of the coating initially formed in step (II) or of a successor liquid coating formed by rinsing the surface of said metal substrate as modified after step (II) with water.

7. A process according to claim 6, in which Y¹ in general formula (I) conforms to general formula (III).

8. A process according to claim 7, in which the waterborne composition provided in step (I) comprises a total of at least 0.01 g/l of phosphorus atoms present in phosphoric acid like compounds and silicon atoms present in organosilicon compounds.

9. A process according to claim 6, in which the waterborne composition provided in step (I) comprises a total of at least 0.01 g/l of phosphorus atoms present in phosphoric acid like compounds and silicon atoms present in organosilicon compounds.

10. A process according to claim 7, wherein the waterborne composition provided in step (I) contains at least 0.1 g/L of polymer molecules comprising units conforming to general formula (I) and the coating of liquid formed in step (II) is rinsed with water so as to form a successor coating before completion of step (III).

11. A process according to claim 10, in which the waterborne composition provided in step (I) comprises a total of at least 0.1 g/l of phosphorus atoms present in phosphoric acid like compounds and silicon atoms present in organosilicon compounds.

12. A process according to claim 6, wherein the waterborne composition provided in step (I) contains at least 0.1 g/L of polymer molecules comprising units conforming to general formula (I) and the coating of liquid formed in step (II) is rinsed with water so as to form a successor coating before completion of step (III).

13. A process according to claim 12, in which the waterborne composition provided in step (I) comprises a total of at least 0.1 g/l of phosphorus atoms present in phosphoric acid like compounds and silicon atoms present in organosilicon compounds.
